(19) United States
(12) Patent Application Publication
(10) Pub. No.: US 2002/0099784 A1
(43) Pub. Date: Jul. 25, 2002

(54) System and method for storing and retrieving bookmark information

(76) Inventor: Trung M. Tran, Round Rock, TX (US)

Correspondence Address: B. Noel Kivlin, Conley, Rose & Tayon, P.C., P. O. Box 398, Austin, TX, 78767-0398, US

(21) Appl. No.: 09/770,994

(22) Filed: Jan. 25, 2001

(51) Int. Cl. G06F 15/167; G06F 15/16

(52) U.S. Cl. 709/212; 709/219; 709/229

(57) ABSTRACT

A system and method for enabling bookmark information to be shared among different computer systems. A method for storing bookmark information is described. User input requesting to store bookmark information may be received, wherein the bookmark information specifies a uniform resource locator (URL) and possibly also specifies other information, such as a name to associate with the URL. If the user does not want to store the bookmark information locally, then the bookmark information may be stored on a server computer system. The method may prompt for and receive user input specifying user authentication information and may interface with the server computer system to authenticate the user. The bookmark information may then be sent to the server computer system. The server computer system may store the bookmark information in association with the particular user. A method for obtaining stored bookmark information is also described. User input requesting to retrieve stored bookmark information may be received. In response, the method may prompt for and receive user input specifying user authentication information. The method may interface with a server computer system to authenticate the user, using the user authentication information. Bookmark information associated with the user may then be received from the server computer system. The bookmark information may specify a plurality of URLs which were previously stored on the server computer system in accordance with the method described above. The methods described above may be utilized to enable a method for sharing bookmark information among different computer systems.

### BACKGROUND OF THE INVENTION

1. Field of the Invention

The present invention relates to the field of application software, and more particularly to a system and method for enabling an application to store bookmark information on and retrieve bookmark information from a server computer, wherein the bookmark information specifies one or more uniform resource locators (URLs).

2. Description of the Related Art

One development that has encouraged the proliferation of inter-networked computer systems and applications has been the development of a standard technique for identifying and accessing network resources. In particular, the standardization of the uniform resource locator (URL) has been important. Uniform resource locators are commonly used to identify virtually any type of resource, including files, executable components, multimedia resources, etc.

For example, a URL can be used to reference a file according to the following format:

protocol://host.domain[:port]/path/filename

The “protocol://” portion specifies a communication protocol to be used in accessing the file. Commonly used protocols include: “http://” (HyperText Transfer Protocol), “ftp://” (File Transfer Protocol), and “file://” (local file system). The “host.domain” portion is the Internet address of the site where the file is located. The “[:port]” portion identifies a port number on a server computer used to access the file. The “/path/” portion specifies where in a directory tree the file is located. The “filename” portion is the name of the file.

A large variety of software applications utilize URLs to reference resources. Applications such as Microsoft Internet Explorer and Netscape Navigator utilize URLs to reference resources on the World Wide Web and are commonly referred to as “web browsers”. However, any of various types of applications, such as word processors, multimedia applications, etc., may utilize URLs to reference resources located on the World Wide Web or elsewhere. As used herein, an application said to have web browsing functionality may refer to any of various applications operable to utilize URLs to reference network resources.

Web browsers and other applications with web-browsing functionality often maintain a list of “bookmarks,” wherein each bookmark specifies a URL. For example, bookmarks are accessible in the Microsoft Internet Explorer application via a “Favorites” menu and are accessible in the Netscape Navigator application via a “Bookmarks” menu. Bookmarks are convenient for users since they provide an easy and quick way to access a URL.

As networked systems and applications penetrate more and more into everyday life, users often find themselves using multiple computer systems. For example, users may use computer systems that are not their own personal computer system. For example, users now commonly use public computer systems located in libraries, cybercafes, etc. Also, users often use multiple computer systems at home and at work. In these situations, a user often desires to access a URL which he had previously created a bookmark for on another computer system. However, the prior art provides no techniques for accomplishing this.

In the prior art, creating a bookmark results in bookmark information being saved locally, that is, on the host computer system that is executing the current application the user is using. However, when the user moves to a different computer system, there is no way for the different computer system to access the previously created bookmark. Thus, in the current conception of a bookmark, bookmarks are associated with a particular computer system. It would be desirable to provide a method wherein the concept of a bookmark is such that bookmarks are associated with users and are independent of any particular computer system. It would also be desirable to provide a method for users to access a set of bookmarks from multiple computer systems. It would also be desirable for the method to be tightly integrated into a user application operable to store, retrieve, and use bookmark information.

### SUMMARY OF THE INVENTION

The problems outlined above may in large part be solved by providing a system and method for enabling bookmark information to be shared among different computer systems, such as described herein. A method for storing bookmark information is described. According to one embodiment of this method, user input requesting to store bookmark information may be received, wherein the bookmark information specifies a uniform resource locator (URL) and possibly also specifies other information, such as a name to associate with the URL. In one embodiment, the method may be operable to store the bookmark information either locally or remotely, depending on what the user desires. If the user wants to store the bookmark information locally then the bookmark information may be stored on the host computer system that is executing a current application the user is using. If the user does not want to store the bookmark information locally, then the bookmark information may be stored on a server computer system.

If the bookmark information is to be stored on the server computer system, then the method may prompt for and receive user input specifying user authentication information, e.g., a username and password. It may be desirable to store the bookmark information on the server computer system in association with the particular user. For example, bookmark information may be stored on the server computer system for multiple users, wherein the bookmark information for each user specifies a set of URLs. Thus, the user authentication information may be used in associating the bookmark information with the correct user. The user authentication information may also be used in verifying the identity of the user, to prevent unauthorized users from adding bookmark information for another user.

After authenticating the user using the user authentication information, the method may operate to send the bookmark information to the server computer system. The server computer system may store the bookmark information, in response to receiving the bookmark information. As described above, the server computer system may store the bookmark information in association with the particular user. Thus, the method may also send user identification information to the server computer system that the server computer system can use to determine the user with which to associate the bookmark information. Storing the bookmark information may comprise adding the bookmark information to existing bookmark information that is already stored for the user.

The bookmark information may be sent to the server computer system in any of various ways. For example, any of various communication protocols may be used to interface with the server computer system. In one embodiment, the Lightweight Directory Access Protocol (LDAP) may be used. In other embodiments, other protocols may be used. For example, a custom TCP and/or IP-based protocol may be defined and implemented.

In one embodiment, an application programming interface (API) may be defined, which enables client applications to communicate with the server computer system to store and/or retrieve bookmark information. For example, the API may include function or method calls for storing bookmark information remotely, retrieving a list of remotely stored bookmarks associated with a particular user, etc. Such an API may enable various types of client applications to easily incorporate the functionality of storing bookmark information remotely and retrieving remotely stored bookmark information. For example, an executable module implementing the API may be created, such as a DLL, shared library, Java module, etc. The client applications may then call the executable module to perform the desired function.

For example, an application having web-browsing functionality may call the executable module via the API to obtain a list of bookmark information stored for a certain user in the server computer system. After obtaining the bookmark information, the application may then enable the user to access the bookmark information via a graphical user interface. For example, for each URL specified by the bookmark information, the URL may be placed in a menu of the application, possibly identified by a name also specified by the bookmark information, such that the user can select the desired URL from the menu, e.g., in order to display or otherwise access the resource referenced by the URL.

A method for obtaining stored bookmark information is also described. According to one embodiment of the method, user input requesting to retrieve stored bookmark information may be received. For example, this user input may be received via a graphical user interface, e.g., when the user selects a “Get My Bookmarks” menu command. In an alternative embodiment, this step may not be necessary. For example, the method may operate to automatically obtain bookmark information, e.g., at application startup time.

In response, the method may prompt for and receive user input specifying user authentication information, e.g., a username and password. The method may interface with a server computer system to authenticate the user, using the user authentication information. As described above, bookmark information stored on the server computer system may be associated with a particular user, and the user authentication may be performed in order to identify the user (identify the appropriate bookmark information to obtain), prevent unauthorized users from obtaining bookmark information for another user, etc.

Bookmark information may then be received from the server computer system. The bookmark information received may be bookmark information that is associated with the user, e.g., as determined by the user authentication information. The bookmark information may specify a plurality of URLs which were previously stored on the server computer system in accordance with the method described above. The bookmark information may also comprise other information, such as a name that is associated with each URL.

Any of various communication protocols may be utilized in retrieving the bookmark information. In one embodiment, the Lightweight Directory Access Protocol (LDAP) may be used. In other embodiments, other protocols may be used. For example, a custom TCP and/or IP-based protocol may be defined and implemented. Also, as described above, an application may call an API to request an executable module to interface with the server computer and may receive the bookmark information from the call to the executable module.

After receiving the bookmark information, the method may enable the user to access the bookmark information via a graphical user interface. As described above, in one embodiment this may comprise placing each URL specified by the bookmark information in a menu such that the user can select the desired URL from the menu, e.g., in order to display or otherwise access the resource referenced by the URL. If bookmark information is organized hierarchically, then the URLs may be nested in the menu according to the appropriate hierarchy.

The methods described above for storing bookmark information and obtaining stored bookmark information may be utilized to enable a method for sharing bookmark information among different computer systems. A first computer system may execute a first software application having web-browsing functionality. The first software application having web-browsing functionality may interface with a server computer system in order to remotely store bookmark information on the server computer system, in accordance with the method described above.

A second computer system may execute a second software application having web-browsing functionality. The second software application having web-browsing functionality may interface with the server computer system in order to retrieve the stored bookmark information, in accordance with the method described above. The second software application having web-browsing functionality may then enable the user to access the retrieved bookmark information via a graphical user interface such as a menu, as described above.

Thus, the method may enable a user to use a common set of bookmarks from the context of different computer systems. When at a first computer system, the user can request to store a bookmark on a server computer system, much the same as the user requests to store a bookmark locally using current web browser applications, with a possible additional step of also specifying user authentication information. After moving to a second computer system, an application on the second computer system may then retrieve the stored bookmark information from the server computer system. The bookmark information may then be tightly integrated into the graphical user interface of the application, such that the user can easily access the bookmark information, e.g., much the same as bookmarks are accessed in current web browser applications.

### BRIEF DESCRIPTION OF THE DRAWINGS

A better understanding of the present invention can be obtained when the following detailed description is considered in conjunction with the following drawings, in which:

FIG. 1 illustrates one embodiment of a system including a client computer system connected via a network to a server computer system;

FIG. 2 is a block diagram illustrating one embodiment of the client computer system shown in FIG. 1;

FIG. 3 is a flowchart diagram illustrating one embodiment of a method for storing bookmark information;

FIG. 4 is a flowchart diagram illustrating one embodiment of a method for obtaining bookmark information; and

FIG. 5 is a flowchart diagram illustrating one embodiment of a method for sharing bookmark information among different computer systems.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

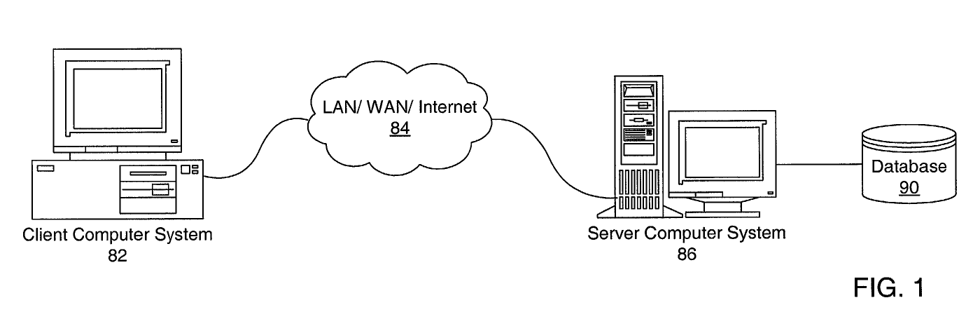

FIG. 1—Client Computer System Connected to a Server Computer System

FIG. 1 illustrates one embodiment of a system including a client computer system 82 connected via a network 84 to a server computer system 86. The client computer system 82 may be a computer system of any type. Defined broadly, a computer system may refer to any system operable to execute program instructions from a memory medium. As examples, in various embodiments, the client computer system 82 may comprise a personal computer, a workstation, a consumer device such as a cellular telephone or personal digital assistant (PDA), a network appliance, etc.

The client computer system 82 may be connected to a network 84. The network 84 may be any type of network, including the Internet, a LAN, or a WAN, among others. As shown, a server computer system 86 may also be connected to the network 84. The server computer system 86 may be a computer system of any type. The network 84 enables the client and server computer systems to communicate with each other. For example, in one embodiment, the network 84 may be the Internet, and the client computer system 82 may communicate with the server computer system 86 using a TCP and/or IP-based protocol.

The client computer system 82 may execute software operable to reference network resources using uniform resource locators (URLs). For example, the client computer system 82 may execute an application having web-browsing functionality that allows users to access, e.g., view, various resources referenced by URLs. The software executed by the client computer system 82 may support the use of bookmarks. Each bookmark may specify a uniform resource locator (URL). In one embodiment, a bookmark may also comprise other information. For example, the URL of a bookmark may be associated with a name. For example, the software may enable users to select from bookmarks via a graphical user interface that displays the name of each bookmark, such as a menu, in order to access the bookmarks, e.g., to access resources referenced by the URLs of the bookmarks.

The client computer system 82 may be operable to retrieve bookmark information from the server computer system 86, wherein the bookmark information specifies one or more URLs. One embodiment of a method for obtaining bookmark information is described below. The client computer system 82 may also be operable to store bookmark information on the server computer system 86. One embodiment of a method for storing bookmark information is described below. As described below, the bookmark information may be stored in association with a particular user. For example, this may allow multiple users to keep their own sets of bookmarks stored on the server computer system.

As shown, the server computer system 86 may utilize a database 90 to store bookmark information received from the client computer system 82. It is noted that FIG. 1 is exemplary only, and the server computer system 86 and/or database 90 may be arbitrarily complex. For example, in order to support a large number of interactions with many client computer systems simultaneously, the server computer system 86 may comprise multiple server computers and/or databases.

The ability to store bookmark information on the server computer system and later retrieve the stored bookmark information may benefit users by allowing them to work with their bookmarks on multiple computer systems. For example, a user of a first client computer system may desire to store bookmark information on the server computer system, wherein the bookmark information specifies a URL. For example, the user may request an application operable to use the URL to store the bookmark information on the server computer system. If the user later moves to a second client computer system, the user may then desire to retrieve the previously stored bookmark information from the server computer system. For example, the user may request an application operable to use the URL to retrieve the bookmark information from the server computer system. The application may then enable the user to access the retrieved bookmark information via a graphical user interface.

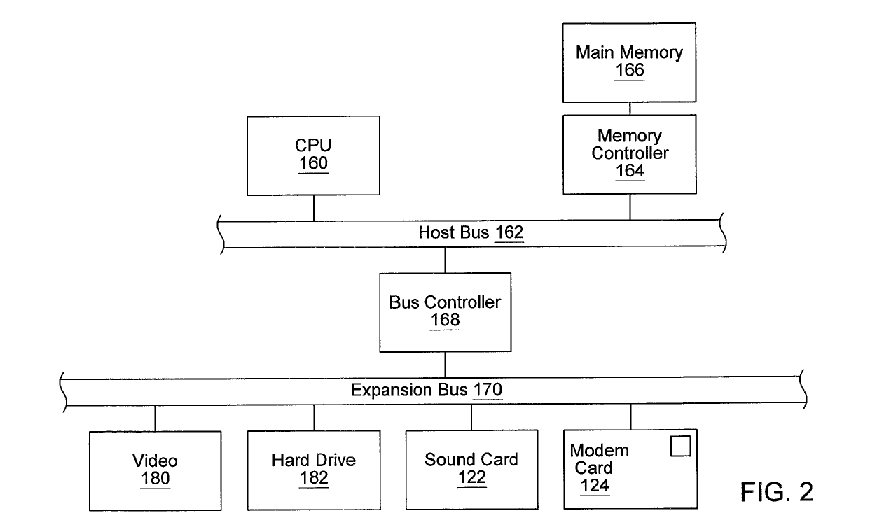

FIG. 2—Client Computer System Block Diagram

FIG. 2 is a block diagram illustrating one embodiment of the client computer system 82 shown in FIG. 1. It is noted that any type of computer system configuration or architecture can be used as desired, and FIG. 2 illustrates a representative PC embodiment. It is also noted that the client computer system 82 may comprise a general purpose computer system, may comprise a consumer device such as a cellular telephone or personal digital assistant (PDA), or may comprise any other type of computer system. Elements of a computer not necessary to understand the present disclosure have been omitted for simplicity.

The computer may include at least one central processing unit or CPU 160 which is coupled to a processor or host bus 162. The CPU 160 may be any of various types, including an x86 processor, e.g., a Pentium class, a PowerPC processor, a CPU from the SPARC family of RISC processors, as well as others. Main memory 166 is coupled to the host bus 162 by means of memory controller 164.

The host bus 162 is coupled to an expansion or input/output bus 170 by means of a bus controller 168 or bus bridge logic. The expansion bus 170 may be any type of bus, inlcuding the PCI (Peripheral Component Interconnect) expansion bus. The expansion bus 170 includes slots for various devices such as the sound card 122 and the modem card 124. The computer further includes a video display subsystem 180 and hard drive 182 coupled to the expansion bus 170.

The main memory 166 may store operating system software as well as other software for operation of the computer system. The main memory 166 may also store a computer program operable to perform one or more of the methods described below for storing bookmark information on a server computer system and/or retrieving bookmark information from the server computer system.

A computer program operable to perform the methods described below may also be stored on other types of memory media. The term “memory medium” is intended to include an installation medium, e.g., a CD-ROM, floppy disks, or tape device, a computer system memory or random access memory such as DRAM, SRAM, EDO RAM, etc., or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide the program instructions to the first computer for execution.

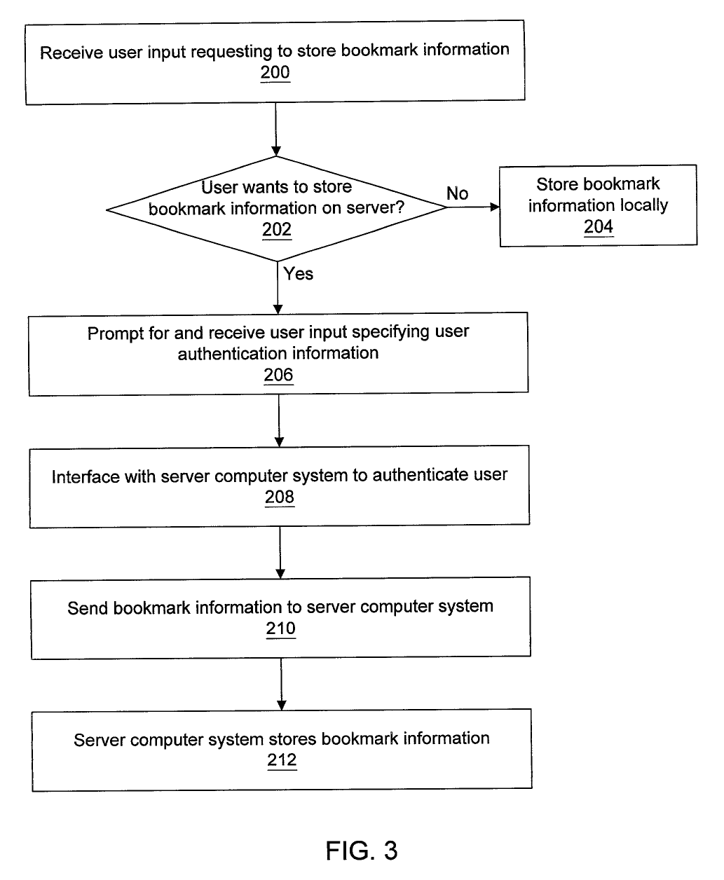

FIG. 3—Storing Bookmark Information

FIG. 3 is a flowchart diagram illustrating one embodiment of a method for storing bookmark information. In one embodiment, the method of FIG. 3 may be performed by the client computer system 82 illustrated in FIG. 1. For example, the method may be implemented by an application having web-browsing functionality that executes on the client computer system 82.

In step 200, user input requesting to store bookmark information may be received, wherein the bookmark information specifies a uniform resource locator (URL). For example, the user may request via a graphical user interface to bookmark a URL, e.g., a URL referencing a resource currently being displayed or otherwise accessed. The user may also specify other information to be associated with the URL. For example, in response to a user request to store bookmark information, the method may present a window or dialog box enabling the user to specify a name to associate with the URL. For example, the URL may be “http://www.sun.com”, and the user may specify a name of “Sun Microsystems”. If bookmark information is categorized hierarchically, the user may also specify a subfolder or other hierarchical location for the new bookmark information.

In one embodiment, the method may be operable to store the bookmark information either locally or remotely, depending on what the user desires. Thus, in step 202, the method may determine whether the user wants to store the bookmark information on a server computer system, such as the sever computer system 86 discussed above with reference to FIG. 1. For example, the dialog box or window that enables the user to specify the bookmark name in step 200 may also enable the user to specify whether to store the bookmark information locally or remotely. Alternatively, there may be separate user commands for storing bookmark information locally and storing bookmark information remotely.

If the user does not want to store the bookmark information on the server computer system, then in step 204, the bookmark information may be stored locally, that is, on the host computer system that is executing the current application the user is using. The bookmark information may be stored locally according to prior art techniques.

If the user does want to store the bookmark information on the server computer system, then in step 206, the method may prompt for and receive user input specifying user authentication information. It may be desirable to store the bookmark information on the server computer system in association with the particular user. For example, bookmark information may be stored on the server computer system for multiple users, wherein the bookmark information for each user specifies a set of URLs. Thus, the user authentication information may be used in associating the bookmark information with the correct user.

The user authentication information may also be used in verifying the identity of the user, to prevent unauthorized users from adding bookmark information for another user. In various embodiments, the user authentication information may comprise any type of information usable to perform an authentication procedure to authenticate the user, such as a username and password, biometric information, etc. Thus, in various embodiments, the method may prompt for and receive the user authentication information in various ways, e.g., by displaying a dialog box for entering a username and password, by receiving fingerprint information via a hardware device, etc.

In step 208, the method may interface with the server computer system in order to authenticate/authorize the user. For example, in one embodiment, authenticating the user may comprise verifying that the password provided correctly matches the username provided.

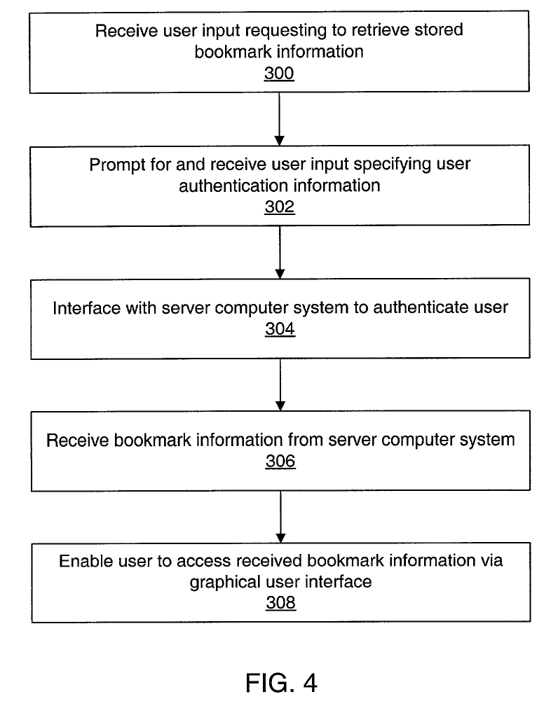

If the user has been authenticated previously, then user information and authentication information may have been stored, making it unnecessary to perform steps 206 and 208. For example, the user may have previously requested to store bookmark information on the server computer system, or the user may have been prompted for user information and authentication information at application startup time. Also, if the user previously entered user authentication information in order to obtain existing stored bookmark information, as described below with reference to FIG. 4, then the user may not need to re-enter the information.

If the user cannot be authenticated, an error may be indicated. Otherwise, in step 210, the method may operate to send the bookmark information to the server computer system. In step 212, the server computer system may store the bookmark information, in response to receiving the bookmark information. As illustrated in FIG. 1, the bookmark information may be stored in a database 90. As described above, the server computer system may store the bookmark information in association with the particular user. Thus, in step 210, the method may also send user identification information to the server computer system that the server computer system can use to determine the user with which to associate the bookmark information. Storing the bookmark information may comprise adding the bookmark information to existing bookmark information that is already stored for the user.

In various embodiments, the server computer system may implement various storage management rules for increasing storage efficiency. For example, if bookmark information is stored for a large number of users and a limited amount of storage space is available, it may be desirable to limit the amount of time that bookmark information is stored. For example, if a user does not access his bookmark information for a period of six months, the server computer system may automatically delete the bookmark information. Also, users may sometimes forget that certain URLs are already bookmarked. Thus, when bookmark information is received, the server computer system may be operable to check to see whether the bookmark information is already stored, and if so, the bookmark information may not be re-stored. The server computer system may send a message to this effect to be indicated to the user.

The method may interface with the server computer system to send the bookmark information to the server computer system in any of various ways. For example, any of various communication protocols may be used to interface with the server computer system. In one embodiment, the Lightweight Directory Access Protocol (LDAP) may be used. In this case, the server computer system may be operable to store the bookmark information using standard LDAP techniques, and thus if the server computer system supports LDAP, then no special modifications may be required to enable the storage of bookmark information.

In other embodiments, other protocols may be used. For example, a custom TCP and/or IP-based protocol may be defined and implemented. For example, a TCP/IP protocol may be operable to marshal bookmark information into a buffer, stream the buffer to the server computer system, receive responses from the server computer system, etc.

In one embodiment, an application programming interface (API) may be defined, which enables client programs to communicate with the server computer system to store and/or retrieve bookmark information. For example, the API may include function or method calls for storing bookmark information remotely, retrieving a list of remotely stored bookmarks associated with a particular user, etc. Such an API may enable various types of client applications to easily incorporate the functionality of storing bookmark information remotely and retrieving remotely stored bookmark information. For example, an executable module implementing the API may be created, such as a DLL, shared library, Java module, etc. The client applications may then call the executable module to perform the desired function.

For example, an application having web-browsing functionality may call the executable module via the API to obtain a list of bookmark information stored for a certain user in the server computer system. After obtaining the bookmark information, the application may then enable the user to access the bookmark information via a graphical user interface. For example, for each URL specified by the bookmark information, the URL may be placed in a menu of the application, possibly identified by a name also specified by the bookmark information, such that the user can select the desired URL from the menu, e.g., in order to display or otherwise access the resource referenced by the URL.

FIG. 4—Obtaining Bookmark Information

FIG. 4 is a flowchart diagram illustrating one embodiment of a method for obtaining bookmark information. In one embodiment, the method of FIG. 4 may be performed by the client computer system 82 illustrated in FIG. 1. For example, the method may be implemented by an application having web-browsing functionality that executes on the client computer system 82.

In step 300, user input requesting to retrieve stored bookmark information may be received. For example, this user input may be received via a graphical user interface, e.g., when the user selects a “Get My Bookmarks” menu command. In an alternative embodiment, step 300 may not be necessary. For example, the method may operate to automatically obtain bookmark information, e.g., at application startup time.

In step 302, the method may prompt for and receive user input specifying user authentication information. Similarly as described above with reference to FIG. 3, any of various types of user authentication information may be received. In step 304, the method may interface with a server computer system to authenticate/authorize the user, using the user authentication information. As described above, bookmark information stored on a server computer system may be associated with a particular user, and steps 302 and 304 may be performed in order to identify the user (identify the appropriate bookmark information to obtain), prevent unauthorized users from obtaining bookmark information for another user, etc.

In step 306, bookmark information may be received from the server computer system. The bookmark information received may be bookmark information that is associated with the user, e.g., as determined by the user authentication information received in step 302. The bookmark information may specify a plurality of URLs which were previously stored on the server computer system in accordance with the method of FIG. 3. As described above, the bookmark information may also comprise other information, such as a name that is associated with each URL.

Similarly as described above with reference to FIG. 3, any of various communication protocols may be utilized in step 306. In one embodiment, the Lightweight Directory Access Protocol (LDAP) may be used. For example, the user authentication information received in step 302 may comprise an LDAP common and/or unique name for the user, and the method may request to retrieve a list of bookmarks stored on the server computer system under that user's LDAP name.

In other embodiments, other protocols may be used. For example, a custom TCP and/or IP-based protocol may be defined and implemented. For example, a TCP/IP protocol may be operable to request the bookmark information from the server computer system, receive the bookmark information from the server computer as a marshaled buffer, etc. Also, as described above, an application may call an API to request an executable module to interface with the server computer and may receive the bookmark information from the call to the executable module.

In step 308, the method may enable the user to access the bookmark information received from the server computer system via a graphical user interface. As described above, in one embodiment this may comprise placing each URL specified by the bookmark information in a menu such that the user can select the desired URL from the menu, e.g., in order to display or otherwise access the resource referenced by the URL. If bookmark information is organized hierarchically, then the URLs may be nested in the menu according to the appropriate hierarchy.

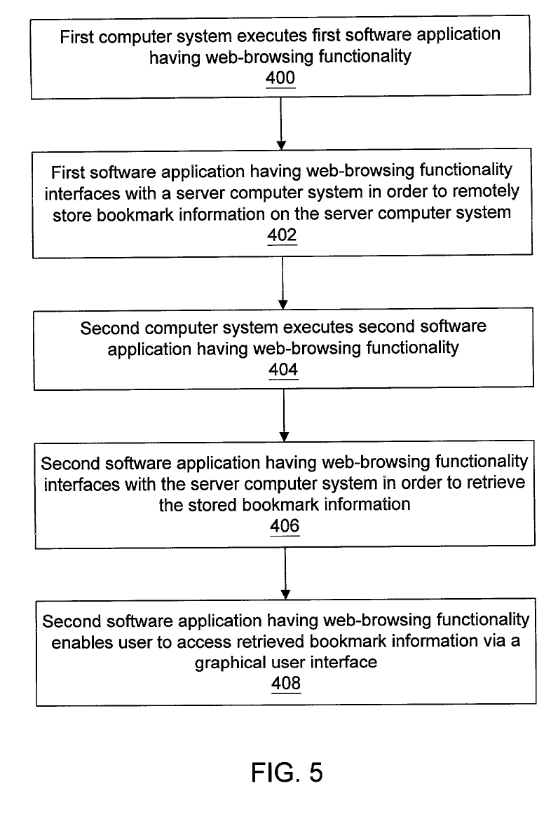

FIG. 5—Sharing Bookmark Information Among Different Computer Systems

FIG. 5 is a flowchart diagram illustrating one embodiment of a method for sharing bookmark information among different computer systems.

In step 400, a first computer system may execute a first software application having web-browsing functionality. The first software application may be operable to utilize URLs in order to access resources for any of various purposes.

In step 402, the first software application having web-browsing functionality may interface with a server computer system in order to remotely store bookmark information on the server computer system. The method of FIG. 3 may be used to perform step 402.

In step 404, a second computer system may execute a second software application having web-browsing functionality. The second software application may be operable to utilize URLs in order to access resources for any of various purposes.

In step 406, the second software application having web-browsing functionality may interface with the server computer system in order to retrieve the stored bookmark information. The method of FIG. 4 may be used to perform step 406.

In step 408, the second software application having web-browsing functionality may enable the user to access the retrieved bookmark information via a graphical user interface such as a menu, as described above.

Thus, the method of FIG. 5 may enable a user to use a common set of bookmarks from the context of different computer systems. When at a first computer system, the user can request to store a bookmark on a server computer system, much the same as the user requests to store a bookmark locally using current web browser applications, with a possible additional step of also specifying user authentication information. After moving to a second computer system, an application on the second computer system may then retrieve the stored bookmark information from the server computer system. The bookmark information may then be tightly integrated into the graphical user interface of the application, such that the user can easily access the bookmark information, e.g., much the same as bookmarks are accessed in current web browser applications.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A client computer system for connection to a server computer system via a network, the client computer system comprising:
a processor;
a memory coupled to the processor;
wherein the processor of the client computer system is operable to execute program instructions stored in the memory to:
receive user input from a user specifying bookmark information, wherein the bookmark information specifies a uniform resource locator (IRL);
receive user authentication information from the user;
communicate with the server computer system to authenticate the user, using the user authentication information;
send the bookmark information for storage in association with the user by the server computer system.

2. The client computer system of claim 1,
wherein said receiving user input from the user specifying bookmark information comprises receiving user input requesting to bookmark the URL.

3. The client computer system of claim 1,
wherein the processor of the client computer system is further operable to execute program instructions stored in the memory to retrieve the bookmark information from the server computer system, subsequently to said sending the bookmark information to the server computer system.

4. The client computer system of claim 3,
wherein the processor of the client computer system is operable to execute a software application;
wherein said sending the bookmark information comprises the software application executing in the client computer system sending the bookmark information;
wherein said retrieving the bookmark information comprises the software application executing in the client computer system retrieving the bookmark information.

5. The client computer system of claim 4,
wherein the software application executing in the client computer system is operable to enable a user to access the retrieved bookmark information via a graphical user interface of the software application.

6. The client computer system of claim 5,
wherein said enabling the user to access the bookmark information via a graphical user interface comprises enabling the user to access the bookmark information via a menu.

7. The client computer system of claim 1, wherein the processor of the client computer system is farther operable to execute program instructions stored in the memory to:
receive user input requesting to store the bookmark information;
determine whether the user wants to store the bookmark information locally or remotely in response to said receiving the user input requesting to store the bookmark information;
store the bookmark information locally if the user wants to store the bookmark information locally;
perform said receiving user authentication information, said communicating with the server computer system to authenticate the user, and said sending the bookmark information for storage by the server computer system if the user wants to store the bookmark information remotely.

8. The client computer system of claim 1,
wherein said communicating with the server computer system to authenticate the user is performed using the Lightweight Directory Access Protocol (LDAP).

9. The client computer system of claim 1,
wherein said sending the bookmark information for storage by the server computer system is performed using the Lightweight Directory Access Protocol (LDAP).

10. A client computer system for connection to a server computer system via a network, the client computer system comprising:
a processor;
a memory coupled to the processor;
wherein the processor of the client computer system is operable to execute program instructions stored in the memory to:
receive user authentication information from a user;
communicate with the server computer system to authenticate the user, using the user authentication information;
communicate with the server computer system to retrieve bookmark information stored in association with the user, wherein the bookmark information specifies one or more uniform resource locators (URLs).

11. The client computer system of claim 10,
wherein the processor of the client computer system is further operable to execute program instructions stored in the memory in order to enable the user to access the retrieved bookmark information via a graphical user interface.

12. The client computer system of claim 11,
wherein said enabling the user to access the retrieved bookmark information comprises enabling the user to access one or more URLs specified by the bookmark information.

13. The client computer system of claim 11,
wherein said enabling the user to access the bookmark information via a graphical user interface comprises enabling the user to access the bookmark information via a menu.

14. The client computer system of claim 10, wherein the processor of the client computer system is further operable to execute program instructions stored in the memory to:
receive user input requesting to retrieve the stored bookmark information;
wherein said receiving the user authentication information, said communicating with the server computer system to authenticate the user, and said communicating with the server computer system to retrieve the bookmark information are performed in response to the user input requesting to retrieve the stored bookmark information.

15. The client computer system of claim 10,
wherein the processor of the client computer system is further operable to execute program instructions stored in the memory to send the bookmark information for storage in association with the user by the server computer system, prior to said communicating with the server computer system to retrieve the bookmark information stored in association with the user.

16. The client computer system of claim 10,
wherein said communicating with the server computer system to authenticate the user is performed using the Lightweight Directory Access Protocol (LDAP).

17. The client computer system of claim 10,
wherein said communicating with the server computer system to retrieve the bookmark information is performed using the Lightweight Directory Access Protocol (LDAP).

18. A method for storing bookmark information, the method comprising:
receiving user input from a user specifying bookmark information, wherein the bookmark information specifies a uniform resource locator (URL);
receiving user authentication information from the user;
communicating with a server computer system to authenticate the user, using the authentication information;
sending the bookmark information for storage in association with the user by the server computer system.

19. The method of claim 18, wherein said receiving the user input specifying the bookmark information and said sending the bookmark information for storage by the server computer system are performed by a first computer system, the method further comprising:
a second computer system retrieving the bookmark information from the server computer system.

20. The method of claim 19,
wherein said second computer system retrieving the bookmark information comprises a software application executing in the second computer system retrieving the bookmark information;
wherein the software application executing in the second computer system is operable to enable a user to access the bookmark information via a graphical user interface.

21. The method of claim 20,
wherein said enabling the user to access the bookmark information via a graphical user interface comprises enabling the user to access the bookmark information via a menu.

22. The method of claim 18, further comprising:
receiving user input requesting to store the bookmark information;
determining whether the user wants to store the bookmark information locally or remotely in response to said receiving the user input requesting to store the bookmark information;
storing the bookmark information locally if the user wants to store the bookmark information locally;
performing said receiving user authentication information, said authenticating the user, and said sending the bookmark information for storage by the server computer system if the user wants to store the bookmark information remotely.

23. The method of claim 18,
wherein said communicating with the server computer system to authenticate the user is performed using the Lightweight Directory Access Protocol (LDAP).

24. The method of claim 18,
wherein said sending the bookmark information for storage by the server computer system is performed using the Lightweight Directory Access Protocol (LDAP).

25. The method of claim 18,
wherein, in storing the bookmark information, the server computer system is operable to add the bookmark information to existing bookmark information that is already stored for the user.

26. A method for obtaining bookmark information, the method comprising:
receiving user authentication information from a user;
communicating with a server computer system to authenticate the user, using the authentication information;
communicating with the server computer system to retrieve bookmark information associated with the user, wherein the bookmark information specifies one or more uniform resource locators (URLs).

27. The method of claim 26, further comprising:
enabling the user to access the bookmark information via a graphical user interface.

28. The method of claim 27,
wherein said enabling the user to access the bookmark information via a graphical user interface comprises enabling the user to access the bookmark information via a menu.

29. The method of claim 26, further comprising:
receiving user input requesting to retrieve the stored bookmark information;
wherein said receiving the user authentication information, said authenticating the user, and said retrieving the bookmark information are performed in response to the user input requesting to retrieve the stored bookmark information.

30. The method of claim 26, wherein said receiving the user authentication information, said authenticating the user, and said retrieving the bookmark information are performed by a first computer system, the method further comprising:
a second computer system communicating with the server computer system in order to store the bookmark information on the server computer system, prior to said retrieving the bookmark information.

31. The method of claim 26,
wherein said communicating with the server computer system to authenticate the user is performed using the Lightweight Directory Access Protocol (LDAP).

32. The method of claim 26,
wherein said retrieving the bookmark information from the server computer system is performed using the Lightweight Directory Access Protocol (LDAP).

33. A method for sharing bookmark information among different computer systems, the method comprising:
a first computer system receiving user input specifying bookmark information, wherein the bookmark information specifies a uniform resource locator (URL);
the first computer system communicating with a server computer system in order to store the bookmark information on the server computer system;
a second computer system communicating with the server computer system in order to retrieve the stored bookmark information.

34. The method of claim 33,
wherein the first computer system includes a first software application having web-browsing functionality;
wherein the second computer system includes a second software application having web-browsing functionality;
wherein said first computer system receiving user input specifying bookmark information comprises the first software application having web-browsing functionality receiving the user input specifying the bookmark information;
wherein said first computer system communicating with the server computer system in order to store the bookmark information on the server computer system comprises the first software application having web-browsing functionality communicating with the server computer system in order to store the bookmark information on the server computer system;
wherein said second computer system communicating with the server computer system in order to retrieve the stored bookmark information comprises the second software application having web-browsing functionality communicating with the server computer system in order to retrieve the stored bookmark information.

35. The method of claim 34, further comprising:
the second software application having web-browsing functionality enabling a user to access the retrieved bookmark information via a graphical user interface.

36. A system for sharing bookmark information between a first computer system and a second computer system, the system comprising:
a first computer system connected via a network to a server computer system, wherein the first computer system includes a processor coupled to a first memory;
a second computer system connected via a network to the server computer system, wherein the second computer system includes a processor coupled to a second memory;
wherein the processor of the first computer system is operable to execute program instructions stored in the first memory in order to send bookmark information to the server computer system, wherein the bookmark information specifies a uniform resource locator (URL);
wherein the server computer system includes a processor coupled to a third memory;
wherein the processor of the server computer system is operable to execute program instructions stored in the third memory in order to receive the bookmark information from the first computer system and store the bookmark information;
wherein the processor of the second computer system is operable to execute program instructions stored in the second memory in order to retrieve the bookmark information from the server computer system.

37. The system of claim 36,
wherein the processor of the second computer system is further operable to execute program instructions stored in the second memory in order to enable a user to access the bookmark information via a graphical user interface.

38. A server computer system for connection to a first client computer system and a second client computer system, wherein the server computer system is configured to:
receive bookmark information from the first client computer, wherein the bookmark information specifies one or more uniform resource locators (URLs);
store the bookmark information in response to receiving the bookmark information;
receive a request for the bookmark information from the second client computer system; and
send the bookmark information to the second client computer system in response to receiving the request from the second client computer system.

39. The server computer system of claim 38, wherein the server computer system is further configured to:
receive first user information, wherein the first user information specifies a particular user;
wherein said storing the bookmark information comprises storing the bookmark information in association with the particular user;
wherein said receiving a request for the bookmark information from the second client computer system comprises receiving second user information, wherein the second user information specifies the particular user.

40. The server computer system of claim 39,
wherein said storing the bookmark information comprises adding the bookmark information to existing bookmark information that is already stored in association with the particular user.

41. The server computer system of claim 38,
wherein said storing the bookmark information comprises storing the bookmark information in a database.

42. A memory medium that stores program instructions executable to:
receive user authentication information from a user;
communicate with a server computer system to authenticate the user, using the user authentication information;
communicate with the server computer system to retrieve bookmark information associated with the user, wherein the bookmark information specifies one or more uniform resource locators (URLs).

43. The memory medium of claim 42, further storing program instructions executable to:
enable the user to access the bookmark information via a graphical user interface.

44. The memory medium of claim 43,
wherein said enabling the user to access the bookmark information via a graphical user interface comprises enabling the user to access the bookmark information via a menu.

45. The memory medium of claim 42, further storing program instructions executable to:
receive user input requesting to retrieve the stored bookmark information;
wherein said receiving the user authentication information, said authenticating the user, and said retrieving the bookmark information are performed in response to the user input requesting to retrieve the stored bookmark information.

46. The memory medium of claim 42,
wherein said communicating with the server computer system to authenticate the user is performed using the Lightweight Directory Access Protocol (LDAP).

47. The memory medium of claim 42,
wherein said retrieving the bookmark information from the server computer system is performed using the Lightweight Directory Access Protocol (LDAP).

48. A memory medium that stores program instructions executable to:
receive user input from a user specifying bookmark information, wherein the bookmark information specifies a uniform resource locator (URL);
receive user authentication information from the user;
communicate with a server computer system to authenticate the user, using the authentication information;
send the bookmark information for storage in association with the user by the server computer system.

49. The memory medium of claim 48, further storing program instructions executable to:
receive user input requesting to store the bookmark information;
determine whether the user wants to store the bookmark information locally or remotely in response to said receiving the user input requesting to store the bookmark information;
store the bookmark information locally if the user wants to store the bookmark information locally;
perform said receiving user authentication information, said authenticating the user, and said sending the bookmark information for storage by the server computer system if the user wants to store the bookmark information remotely.

50. The memory medium of claim 48,
wherein said communicating with the server computer system to authenticate the user is performed using the Lightweight Directory Access Protocol (LDAP).

51. The memory medium of claim 48,
wherein said sending the bookmark information for storage by the server computer system is performed using the Lightweight Directory Access Protocol (LDAP).
